(19) United States
(12) Patent Application Publication
(10) Pub. No.: US 2003/0018593 A1
(43) Pub. Date: Jan. 23, 2003

(54) Intelligent on/off button

(76) Inventor: Man Wei Lee, Singapore (SG)

Correspondence Address: HEWLETT-PACKARD COMPANY, Intellectual Property Administration, P.O. Box 272400, Fort Collins, CO, 80527-2400, US

(21) Appl. No.: 09/876,669

(22) Filed: Jun. 7, 2001

(51) Int. Cl. G06E 1/00; G06N 1/00; G06E 3/00; G06G 7/00; G06F 15/00; G06F 15/16; G06F 15/18; G06F 17/00; G06F 17/20; G06F 9/455

(52) U.S. Cl. 706/10; 706/11

(57) ABSTRACT

An intelligent method is provided to interpret a user's intention whenever an on/off button is activated. The method uses one or several activities to gauge the likelihood of a user's intention to switch off the device when the on/off button is activated. Such activities include the presence of an active network connection and time lapsed since a last keyboard activity or a pointer activity. If the user is in the midst of certain tasks as defined by the activities, a user prompt will seek the user's confirmation to switch off the device. Otherwise, the device switches off without prompting the user.

### FIELD OF THE INVENTION

The present invention pertains to a method of interpreting a user's intention whenever an on/off button is activated, using one or several predefined activities.

### BACKGROUND OF THE INVENTION

Portable devices typically provide an on/off button that a user activates to switch on or to switch off the device. The on/off button may be variously located on the device described as follows. For a device with a miniature keyboard, such as, a held hand PC, the on/off button may be provided as one of the keys on the keyboard. For a device without a keyboard, such as, a personal organizer, the on/off button may be arranged on the casing of the device.

In a device with a miniature keyboard, the layout of the keyboard has to be tightly arranged. Consequently, the space between the miniature keys has to be so constrained such that users have little space to move their fingers freely while typing. Users have to be more careful to avoid accidentally pressing unintended keys. As the on/off button is provided as one of the keys on the keyboard, users are likely to press and activate this button accidentally while typing. Furthermore, the on/off button is usually arranged on a far top right hand corner of the miniature keyboard or at the position of the ‘Backspace’ key in a standard QWERTY keyboard. Users are also likely to unwittingly press the on/off button thinking that it is a ‘Backspace’ key.

Despite the unintentional activation of the on/off button, the device performs a ‘Shut down’ on all running application programs and switches off. Usually, a user merely waits for a few seconds or so to be able to continue using the device after switching it on again. The device and its operating environment are designed to start up quickly as a typical user switches on and switches off the device frequently. However, if the user were connected to a network, for example, via a dialup modem, the network connection would be disconnected. Reconnection would take at least several minutes by first starting up the device and then activating the network connection. If the user were then downloading files, the user would have to start up the device, reconnect to the network and restart the downloading process. This could take up to hours if the user were downloading megabyte-sized files. Hence, whenever the on/off button is accidentally activated, users are unnecessarily interrupted and annoyed by time lost.

One possible solution to address this problem is to display a prompt screen whenever the on/off button is activated to seek a user's confirmation to shut down the device. However, if a user were to accidentally activate the on/off button intermittently while typing, he would have to respond to the prompt each time the on/off button is activated. Although this solution ensures that only a user's genuine intentions are executed, users are also unnecessarily interrupted and annoyed by having to respond to the user prompt. Since a typical user of such portable devices is likely to switch on and switch off the device frequently, a user who genuinely wants to shut down the device would be delayed by having to perform an additional confirmation step.

In view of the current user experience, it is desirable to provide in the portable device an intelligent on/off button capable of interpreting a user's genuine intention without unnecessary prompting and interruption whenever the on/off button is activated.

### SUMMARY OF THE INVENTION

The present invention provides an intelligent method of interpreting a user's intention whenever an on/off button is activated.

When an on/off button of a computer-based device is activated, a sequence is executed to intelligently interpret a user's intention. For this interpretation purpose, a processor activity or a user activity or an applications activity or a combination thereof is used. The activity is recent or ongoing at the time of activating the on/off button. Some examples: are an active network connection, a keyboard activity, a pointer activity, a program installation activity, a network activity such as a file transfer activity and a downloading activity, similar activities that is time-consuming in restarting or reprocessing and any activity according to a user's preference. Such activities will be referred hereinafter as interpretive activities or activities.

These activities are interpretive because they characterize a user usage pattern and thereby interpreting the user's intentions. For example, if a user were connecting to a network and in the midst of downloading files, it is unlikely that he would intend to switch off the device at this time. Similarly, if a user were typing within the last two seconds, it is likely that he were performing some tasks and did not intend to switch off the device at this time.

By detecting the presence or absence of any such interpretive activity, a user's intention is intelligently determined. Based on a predetermined logic, if a sequence determines that the user is likely to switch off the device, the device switches off without prompting the user for confirmation. If the sequence determined that the user is not likely to switch off the device, a user prompt is displayed to seek a user's confirmation. Based on the user's choice, the device will switch off the device or resume operation accordingly.

As users' usage characteristic differ, an interpretive activity may be chosen to be used singly or in combination as desired by a user or a manufacturer. An advantage of using interpretive activities in combination is it provides more accurate characterization of usage pattern and thus leads to closer interpretation of a user's intention.

### BRIEF DESCRIPTION OF THE DRAWINGS

FIG. 1 is an example of a device in which the present invention is used.

FIG. 2 is a flow diagram of a sequence employing one activity, i.e., presence of active network connection, with two user options.

FIG. 3 is a flow diagram of a sequence employing one activity, i.e., presence of active network connection, with three user options.

FIG. 4 is a screenshot of an example of a user prompt with three options.

FIG. 5 is a flow diagram of a sequence employing several activities in combination, i.e., presence of active network connection and time lapsed since last keyboard or pointer activity.

### DETAILED DESCRIPTION OF THE INVENTION

The present invention is applied in portable devices, such as, PDAs, handheld PCs, personal organizers, palmtops and hybrid (or multifunctional) devices, e.g., a mobile phone with PDA functions. The present invention may be likewise applied in desktop computing systems.

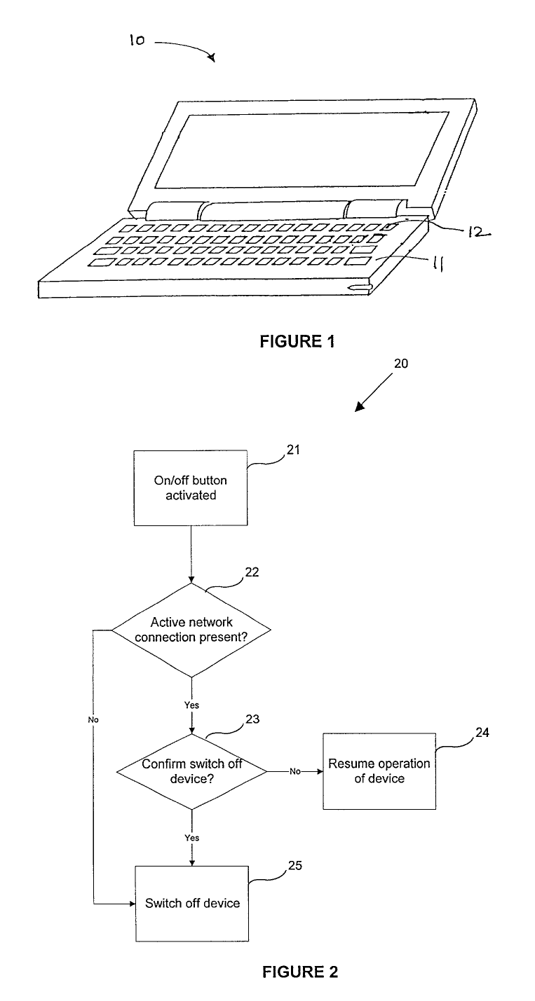

Reference is made to FIG. 1. A handheld personal computer (PC) is used here to illustrate a portable device 10 used in this invention. The device 10 incorporates a miniature keyboard 11 arranged as an integral part of the device 10. Though not limited to such an arrangement, an on/off button 12 is typically arranged on a far top right hand corner of the keyboard 11 as shown.

In a portable device without a keyboard (not shown), the on/off button may be arranged on a surface of the casing of the device. The device may also be connected to an external keyboard separate from the device. The present invention, however, is equally applicable in a similar way.

A sequential aspect of the present invention is now described with reference to FIG. 2.

When a user depresses or activates on/off button 12, a sequence 20 begins with an ON/OFF BUTTON ACTIVATED step 21. The sequence 20 then proceeds to an ACTIVE NETWORK CONNECTION PRESENT? decision step 22 in which a processor detects a presence or an absence of an active network connection. If an active network connection is absent, the sequence 20 proceeds to a SWITCH OFF DEVICE step 25, where all applications are shut down and the device is switched off. Running applications include foreground and background processes (or tasks). This sequence of steps through 21, 22 and, 25 is transparent to the user and the user does not receive any user prompt seeking his confirmation input. In this case, even if the user had not intended to switch off the device, restarting the device would not be as time-consuming as compared to when an active network connection were present.

If an active network connection is present, the sequence 20 proceeds to a CONFIRM SWITCH OFF DEVICE? decision step 23. As it is unlikely of a user to switch off the device while connecting to a network, a user prompt is displayed to seek the user's confirmation for closing all applications and active connections. If the user chooses to switch off the device, the user inputs his choice by selecting an indicator corresponding to that choice or by using other conventional ways. The sequence 20 then proceeds to a SWITCH OFF DEVICE step 25 where all applications and connections are closed and the device 10 is switched off. If the user chooses not to switch off the device, he inputs his choice and the sequence then proceeds to a RESUME OPERATION OF DEVICE step 24. In the RESUME OPERATION OF DEVICE step 24, the processor does not execute the action arising from the activated on/off button to shut down the all applications and switch off the device. Instead, the applications and network activity resume without interruption.

The fore-mentioned user prompt at the CONFIRM SWITCH OFF DEVICE? decision step 23 presents two choices to the user. Alternatively, more choices may be presented to the user as described in the ensuing paragraph.

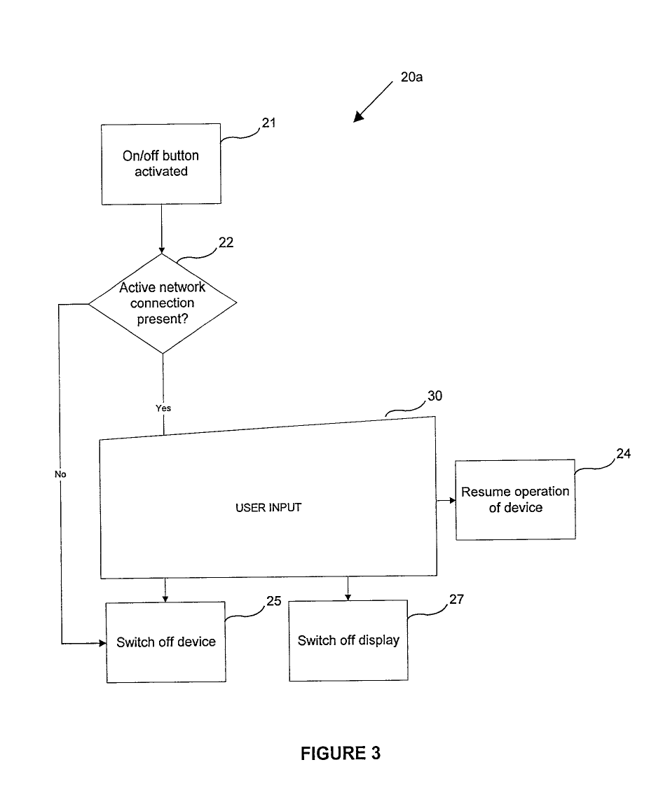

In FIG. 3, a sequence 20a describes a similar ON/OFF BUTTON ACTIVATED step 21 and an ACTIVE NETWORK CONNECTION PRESENT? decision step 22. The ACTIVE NETWORK CONNECTION PRESENT? decision step 22 leads to a SWITCH OFF DEVICE step 25 if there is no active network connection. If there is an active network connection, the sequence 20a proceeds to a USER INPUT step 30. The USER INPUT step 30 displays a user prompt 34 containing three user choices, which prompts a user to input his choice before the sequence proceeds accordingly.

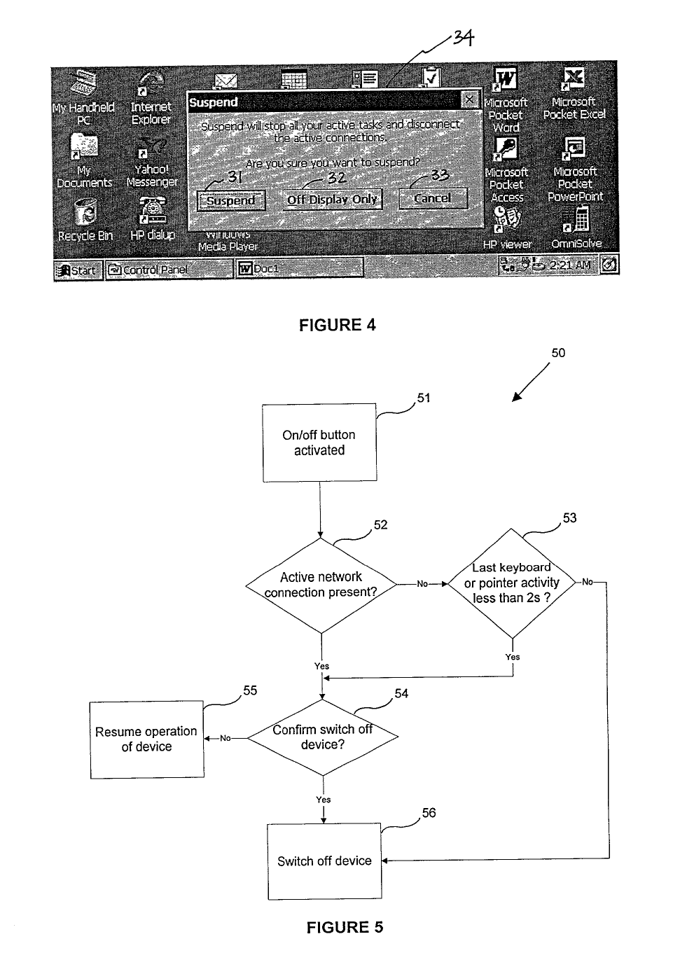

An example of a user prompt 34 containing three choices: ‘Suspend’, ‘Off Display Only’ and ‘Cancel’, is shown in FIG. 4. If the user selects the ‘Suspend’ button 31, the sequence 20a proceeds to a SWITCH OFF DEVICE step 25. All applications will be closed, all active network connections will be disconnected and the device will be switched off. If the user selects the ‘Off Display Only’ button 32, the sequence 20a proceeds to a SWITCH OFF DISPLAY step 27. The display will be switched off but all applications and connections are uninterrupted. The user may switch on the display at a later time in a manner known to a person skilled in the art. If the user selects the ‘Cancel’ button 33, the sequence 20a proceeds to a RESUME OPERATION OF DEVICE step 24. All applications and network connections resume without disruption.

The foregoing sequence 20 can be extended to include more user choices without departing from the spirit of the invention.

As alternatives to using the presence or absence of active network connection to intelligently determine whether to shut down the device whenever the on/off button is activated, other interpretive activities that characterize a typical user usage pattern can also be used interchangeably or in combination. These activities are usually ongoing or recent at the time of activating the on/off button. Examples of such activities are a keyboard activity, a pointer activity, a program installation activity, a synchronization activity, and a network activity such as a file transfer activity and a file download activity. The presence of any such interpretive activity often indicates that the device is actively in use and that the user is not likely to switch off the device within a time period. The time period varies according to the nature of each activity.

Sequence 20 describes using a single user activity in a decision step 22 to determine whether to switch off the device 10. Other interpretive activities can be used interchangeably to work similarly. For example, the decision step 22 can be replaced by a LAST KEYBOARD ACTIVITY LESS THAN 2 SECONDS? decision step, or by a LAST POINTER ACTIVITY LESS THAN 2 SECONDS? decision step, or by a PROGRAM INSTALLATION IN PROGRESS? decision step, or the like.

Alternatively, several interpretive activities can be used in combination to intelligently interpret a user's intention. As an illustration, reference is made to FIG. 5 where a combination of active network connection, keyboard activity and pointer activity are used.

A sequence 50 begins with an ON/OFF BUTTON ACTIVATED step 51 similar to that in sequence 20. The ON/OFF BUTTON ACTIVATED step 51 proceeds to an ACTIVE NETWORK CONNECTION PRESENT? decision step 52. If an active network connection is absent, the sequence 50 proceeds to a LAST KEYBOARD OR POINTER ACTIVITY LESS THAN 2 SECONDS? decision step 53.

At the LAST KEYBOARD OR POINTER ACTIVITY LESS THAN 2 SECONDS? decision step 53, time lapsed since a last keyboard or a pointer activity is calculated and compared against a predetermined reference of two seconds. If the last keyboard or pointer activity occurred more than two seconds ago, the sequence 50 proceeds to a SWITCH OFF DEVICE step 56, where all applications shut down and the device switches off. This sequence of steps through 51, 52, 53 and 56 is transparent to the user. If the last keyboard activity occurred within the last two seconds, the sequence proceeds to a CONFIRM SWITCH OFF DEVICE? step 56.

At the CONFIRM SWITCH OFF DEVICE? decision step 54, a user prompt is displayed to seek the user's confirmation. If the user chooses not to switch off the device, the sequence 50 proceeds to a RESUME OPERATION OF DEVICE step 55 where all applications resume without disruption. If the user chooses to switch off the device, the sequence proceeds to a SWITCH OFF DEVICE step 56.

If an active network connection is present, the sequence 50 proceeds to a CONFIRM SWITCH OFF DEVICE? decision step 54. A user prompt is displayed to seek a user's confirmation for closing all applications and switch off the device. If the user chooses to switch off the device, the user inputs his choice by selecting an indicator corresponding to that choice or by using other conventional ways. The sequence 50 then proceeds to a SWITCH OFF DEVICE step 56 where all applications and connections are closed and the device 10 is switched off. If the user chooses not to switch off the device, he inputs his choice and the sequence then proceeds to a RESUME OPERATION OF DEVICE step 55. In the RESUME OPERATION OF DEVICE step 55, the processor does not execute the action arising from the activated on/off button to shut down all applications and switch off the device. Instead, the applications and network activity resume without interruption.

Alternative to presenting users with only two choices, the users may be presented with more choices such as those illustrated in FIG. 4 and described for sequence 20.

The time period for last keyboard or pointer activity is set at two seconds for illustrative purposes only; it is not limited to be so. It is predetermined and may be optimally programmed in accordance to a user's or a manufacturer's preference.

I claim:

1. A method of implementing an intelligent on/off button in a computer-based device comprising the steps of:
activating the on/off button;
ascertaining a presence or an absence of at least one predefined activity associated to a foreground or background application, wherein the at least one predefined activity is recent or ongoing when the on/off button is activated; and
determining a switching off of the device as a result of the presence or the absence of the at least one predefined activity.

2. The method recited in claim 1 further comprising after determining a switching off of the device as a result of the presence or the absence of the at least one predefined activity, switching off the device.

3. The method recited in claim 1 further comprising after ascertaining the presence or the absence of at least one predefined activity:
displaying a user prompt with options which includes switching off the device; and
receiving a user input in response to the displayed user prompt.

4. The method recited in claim 3 further comprising after receiving the user input, switching off the device or switching off a display or resuming operation of the device.

5. The method recited in claim 1, wherein the predefined activity is an active network connection, or a keyboard activity within a last predetermined time interval, or a pointer activity within a last predetermined time interval, or an installation activity within a last predetermined time interval, or a file transfer activity, or a synchronization activity.

6. A computer-readable media containing program instructions for implementing an on/off button comprising:
means for activating the on/off button;
means for ascertaining a presence or an absence of at least one predefined activity associated to a foreground or background application, wherein the at least one predefined activity is recent or ongoing when the on/off button is activated; and
means for determining a switching off of the device as a result of the presence or the absence of the at least one predefined activity.

7. The apparatus recited in claim 6 further comprising means for switching off the device after determining a switching off of the device as a result of the presence or the absence of the at least one predefined activity.

8. The apparatus recited in claim 6 further comprising:
means for displaying a user prompt with options which includes switching off the device; and
means for receiving a user input in response to the displayed user prompt.

9. The apparatus recited in claim 8 further comprising means for switching off the device or switching off a display or resuming operation of the device after receiving the user input.

10. The apparatus recited in claim 6, wherein the predefined activity is an active network connection, or a keyboard activity within a last predetermined time interval, or a pointer activity within a last predetermined time interval, or an installation activity within a last predetermined time interval, or a file transfer activity, or a synchronization activity.
